(19) United States
(12) Patent Application Publication
(10) Pub. No.: US 2003/0134645 A1
(43) Pub. Date: Jul. 17, 2003

(54) Method and apparatus for providing data

(76) Inventors: Edith H. Stern, Yorktown Heights, NY (US); Philip Shi-Lung Yu, Chappaqua, NY (US); David P. Greene, Ossining, NY (US); Barry E. Willner, Briarcliff Manor, NY (US)

Correspondence Address: BUCKLEY, MASCHOFF, TALWALKAR, & ALLISON, 5 ELM STREET, NEW CANAAN, CT, 06840, US

(21) Appl. No.: 10/047,621

(22) Filed: Jan. 16, 2002

(51) Int. Cl. H04Q 7/20

(52) U.S. Cl. 455/456; 455/450

(57) ABSTRACT

A system, method, apparatus, and computer program code for providing data. According to embodiments of the present invention, a system or method allows a device or entity to provide data to a data perimeter of one or more transmitters, the data being associated with a particular device, location and/or person. A data perimeter may allow a person or device to receive information or other data and/or may form a virtual or intangible boundary created by wireless transmission of the data by one or more transmitters.

### FIELD OF THE INVENTION

The present invention relates to a method and apparatus for providing data and, more particularly, embodiments of the present invention relate to methods, apparatus, and computer program code for using a data perimeter to provide data regarding a person or location.

### BACKGROUND OF THE INVENTION

There are many reasons why a particular location may have restrictions associated with it. For example, a location having temporary or permanent restrictions on use or access may be established for a military installation, airport, school home, business, etc. As more specific examples, a military installation may allow access to only certain government personnel, a school may prevent use of radios within the school premises, and a national park may establish a no-fishing or hunting area. As another example, an area around a building that is on fire may be restricted for a period of time such that only fireman, police, or other emergency personnel are allowed access to the area. Other temporary restrictions may be set up around areas of danger zones (e.g., an area in the path of a tornado), an area around an object (e.g., a painting of which photographs may not be taken while the painting is on exhibit), etc.

In some situations, a restricted area may be associated with or established around an individual (e.g., U.S. President) or group of people. The restricted area may move as the individual or group moves.

While some areas may have physical barriers (e.g., fences) associated with them, such physical barriers may be difficult to establish, particularly if the area changes or moves. Moreover, such barriers can do little, if anything, to provide information or other data regarding the area, a restriction associated with the area, or other information associated with the area or a person or device in the area. As another shortcoming, physical barriers inhibt and can even prevent specific information from being received by a specific person or device.

Some prior art systems may use a radio transmission provide information. For example, a sign posted near a national park or airport may indicate a radio signal frequency at which information about the national park or airport can be received. Unfortunately, the same information is received by all people tuning into the proper frequency and is not personalized or customized to any particular person or device.

It would be advantageous to provide a method and apparatus that overcame the drawbacks of the prior art. In particular, it would be desirable to provide a method and apparatus that allowed data to be provided to a person or device while such person or device is in a specific location. In addition, it would be desirable to provide a method and apparatus that allowed a data perimeter to be established around an individual, object, geographic area or other type of location such that devices or people at the location can receive information.

### SUMMARY OF THE INVENTION

Embodiments of the present invention provide a system, method, apparatus, and computer program code for providing data via a data perimeter. According to embodiments of the present invention, a data perimeter may include one or more transmitters, some or all of which may continuously, randomly, periodically, etc. transmit data via a wireless signal. A person in a location specified as part of a data perimeter may receive the data. In some embodiments, the person may need a password, subscription, permission, etc. to receive the data. The data may provide information regarding the location (e.g., a warning not to enter the location, a notice regarding permissible activities at the location), information regarding or helpful to a person in the location (e.g., estimate of time remaining to arrive at a destination, indication of current parking lot in use for an attraction, notification of a bridge being raised), information regarding or associated with a preference, profile or subscription of a person, or other information. A data perimeter may allow a person or device to receive information or other data and/or may form a virtual or intangible boundary created by wireless transmission of the data by one or more transmitters. Data perimeters may establish or follow limits with regard to hunting, fishing, no fly zones, ecologically sensitive areas, military installations, schools, airports, hospitals, or other areas to provide information regarding these areas.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating delivery of data may include determining a location associated with a device, wherein the device is associated with a person; determining data associated with the person; determining a plurality of transmitters based, at least in part, on the location, wherein at least one of the plurality of transmitters is capable of transmitting data via a wireless signal to the device; and providing the data associated with the person to at least one of the plurality of transmitters. In another embodiment, a method for facilitating delivery of data, may include determining a location associated with a person; determining data associated with the person; associating a data perimeter with the person based, at least in part, on the location, the perimeter including at least one transmitter capable of transmitting a wireless signal; and providing the data to at least one transmitter. In a further embodiment, a method for facilitating delivery of data may include determining a data perimeter associated with a person, wherein the data perimeter includes at least one transmitter capable of sending a wireless signal; determining data to be provided to the person; and providing the data to the data perimeter. In yet another embodiment, a method for facilitating delivery of data may include determining data to be provided at a location; determining a data perimeter associated with the location, wherein the data perimeter includes at least one transmitter capable of sending a wireless signal; and providing the data to the data perimeter. In a still further embodiment, a method for facilitating delivery of data may include determining a device associated with a person; determining data associated with a data perimeter, wherein the data is to be provided to the device; and providing the data to the device.

According to embodiments of the present invention, a system for facilitating delivery of data may include a memory; a communication port; and a processor connected to the memory and the communication port, the processor being operative to determine a location associated with a device, wherein the device is associated with a person; determine data associated with the person; determine a plurality of transmitters based, at least in part, on the location, wherein at least one of the plurality of transmitters is capable of transmitting data via a wireless signal to the device; and provide the data associated with the person to at least one of the plurality of transmitters. In another embodiment, the processor instead may be operative to determine a location associated with a person; determine data associated with the person; associate a data perimeter with the person based, at least in part, on the location, the perimeter including at least one transmitter capable of transmitting a wireless signal; and provide the data to at least one of the at least one transmitters. In a further embodiment, a method for facilitating delivery of data may include determining a data perimeter associated with a person, wherein the data perimeter includes at least one transmitter capable of sending a wireless signal; determining data to be provided to the person; and providing the data to the data perimeter. In yet another embodiment, the processor instead may be operative to determine data to be provided at a location; determine a data perimeter associated with the location, wherein the data perimeter includes at least one transmitter capable of sending a wireless signal; and provide the data to the data perimeter. In a still further embodiment, the processor instead may be operative to determine a device associated with a person; determine data associated with a data perimeter, wherein the data is to be provided to the device; and provide the data to the device.

According to embodiments of the present invention, a computer program product in a computer readable medium for facilitating delivery of data may include first instructions for identifying a location associated with a device, wherein the device is associated with a person; second instructions for identifying data associated with the person; third instructions for identifying a plurality of transmitters based, at least in part, on the location, wherein at least one of the plurality of transmitters is capable of transmitting data via a wireless signal to the device; and fourth instructions for sending the data associated with the person to at least one of the plurality of transmitters. In another embodiment, a computer program product in a computer readable medium for facilitating delivery of data, may include first instructions for identifying a location associated with a person; second instructions for identifying data associated with the person; third instructions for determining a data perimeter associated with the person based, at least in part, on the location, the perimeter including at least one transmitter capable of transmitting a wireless signal; and fourth instructions for sending the data to at least one of the at least one transmitter. In a further embodiment, a computer program product in a computer readable medium for facilitating delivery of data may include first instructions for identifying a data perimeter associated with a person, wherein the data perimeter includes at least one transmitter capable of sending a wireless signal; second instructions for identifying data to be provided to the person; and third instructions for sending the data to the data perimeter. In yet another embodiment, a computer program product in a computer readable medium for facilitating delivery of data may include first instructions for identifying data to be provided at a location; second instructions for identifying a data perimeter associated with the location, wherein the data perimeter includes at least one transmitter capable of sending a wireless signal; and third instructions for sending the data to the data perimeter. In a still further embodiment, a computer program product in a computer readable medium for facilitating delivery of data may include first instructions for identifying a device associated with a person; second instructions for identifying data associated with a data perimeter, wherein the data is to be provided to the device; and third instructions for sending the data to the device.

According to embodiments of the present invention, an apparatus for facilitating delivery of data may include means for identifying a location associated with a device, wherein the device is associated with a person; means for identifying data associated with the person; means for identifying a plurality of transmitters based, at least in part, on the location, wherein at least one of the plurality of transmitters is capable of transmitting data via a wireless signal to the device; and means for sending the data associated with the person to at least one of the plurality of transmitters. In another embodiment, an apparatus for facilitating delivery of data, may include means for identifying a location associated with a person; means for identifying data associated with the person; means for determining a data perimeter associated with the person based, at least in part, on the location, the perimeter including at least one transmitter capable of transmitting a wireless signal; and means for sending the data to at least one transmitter. In a further embodiment, an apparatus for facilitating delivery of data may include means for identifying a data perimeter associated with a person, wherein the data perimeter includes at least one transmitter capable of sending a wireless signal; means for identifying data to be provided to the person; and means for sending the data to the data perimeter. In yet another embodiment, an apparatus for facilitating delivery of data may include means for identifying data to be provided at a location; means for identifying a data perimeter associated with the location, wherein the data perimeter includes at least one transmitter capable of sending a wireless signal; and means for sending the data to the data perimeter. In a still further embodiment, an apparatus for facilitating delivery of data may include means for identifying a device associated with a person; means for identifying data associated with a data perimeter, wherein the data is to be provided to the device; and means for sending the data to the device.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a flowchart of a fourth embodiment of a method in accordance with the present invention;

FIG. 5 is a flowchart of a fifth embodiment of a method in accordance with the present invention;

FIG. 6 is a block diagram of system components for an embodiment of an apparatus usable with the methods of FIGS. 1-5;

FIG. 7 is a block diagram of a transmitter configuration used with one of the data perimeters of FIG. 6;

FIG. 8 is a block diagram of system components for an embodiment of a server of FIG. 6;

FIG. 9 is an illustration of a representative user information database of FIG. 8;

FIG. 10 is an illustration of a representative user device information database of FIG. 8;

FIG. 11 is an illustration of a representative data perimeter information database of FIG. 8;

FIG. 12 is an illustration of a representative data information database of FIG. 8; and

FIG. 13 is an illustration of a representative transmitter information database of FIG. 8.

### DETAILED DESCRIPTION

Applicants have recognized that there is a need for systems and methods that allow a device or entity to provide data to a data perimeter of one or more transmitters, the data being associated with a particular device, location and/or person. A data perimeter may allow a person or device to receive information or other data and/or may form a virtual or intangible boundary created by wireless transmission of the data by one or more transmitters. Data perimeters may establish or follow limits with regard to hunting, fishing, no fly zones, ecologically sensitive areas, military installations, schools, airports, hospitals, or other areas to provide information regarding these areas. For example, a person may subscribe to a data perimeter service. The person may have location awareness capability (e.g., GPS tracking) in a device carried by the person. The device may inform the service on a regular or irregular basis regarding the person's location. The service may then provide information or other data to the person or device. The data may be tailored to the specific location, person, etc. As the person moves from one location to another location, a new or moving data perimeter may be established. In some embodiments, the person may subscribe to a service that allows or entitles the person to receive data via one or more data perimeters. The data and/or the data perimeters may change over time, as a person moves from one location to another location, as a person uses different devices, etc.

In another example, a construction area may use a data perimeter to provide warnings or other data to people near or entering the area. The warnings may change depending on activity in the construction area.

As a further example, a data perimeter may be established around a vehicle carrying an important person (e.g., U.S. President). The data perimeter may include one or more transmitters that transmit a wireless signal warning people not to come with twenty feet of the vehicle or the person. Thus, the data provided by the data perimeter is related to the location, which is moving, not to a specific recipient of the data.

As illustrated by the examples above, in some embodiments data may be transmitted by a data perimeter that is related to a recipient of the data, the location of the data perimeter, the location of the recipient of the data, etc. A data perimeter may be stationary or mobile, temporary or permanent, and include one or more transmitters that are stationary or mobile, or temporary or permanent. These and other features will be discussed in further detail below, by describing a system, individual devices, and processes according to embodiments of the invention.

Process Description

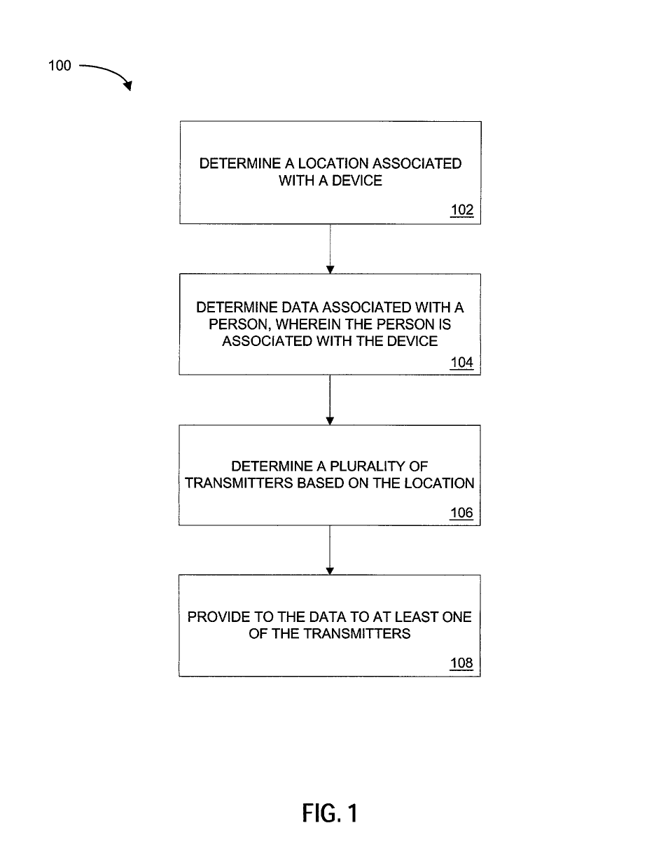

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below. The method 100 is particularly suited to provide information to a person via a device carried by the person and a data perimeter within range of the device.

Processing begins at a step 102 during which a location associated with a device is determined. The location may be a specific point (e.g., specific latitude and longitude, specific GPS location), an absolute or relative spot or area, a specific location of an individual, object, vehicle, etc., a geographic area (e.g., city, city block, parcel of land, estate, lot, country, street, national park, area within a building), an area surrounding an individual, object, vehicle, building, etc., an area within a designated distance from an individual, vehicle, object, a boundary of a geographic area, an area within a range of GPS points or other geographically designating data, a geographic area having a specific profile (e.g., fire zone, area under a tornado warning, evacuation area, testing area), specific longitude and latitude, GPS point, etc., or some other location. A location may be of any size or shape and may change over time. A location may follow or include natural or geographic boundary lines (e.g., a river or street), national boundaries, etc. For example, a location may have a fixed boundary but be moving (e.g., an area surrounding ten feet of an automobile carrying the U.S. President). As another example, a boundary may be flexible and moving (e.g. an area within ten feet of a presidential motorcade which may vary in size). Thus, in some embodiments, a location may be fixed or movable and/or the location may have a fixed or movable boundary.

In some embodiments, the device may be associated directly or indirectly with one or more people. For example, a device might be a computer, cellular telephone, personal digital assistant (PDA), two-way pager, radio, television, etc. carried by a person (e.g., traveler, salesman) or a group of people (e.g., a group of travelers or hikers). In some embodiments, the device may be capable of sending and/or receiving data via a wireless signal, a Bluetooth™ enabled communication device, a user device, a server, or some other device.

As one example of the step 102, a device or entity implementing the step 102 or the method 100 may receive a message or other indication from a device regarding its location (e.g., a signal providing GPS coordinates of the device). As another example, a person may indicate that he or she is or soon will be located in a specific city, hotel, business, etc. The device or entity implementing the step 102 or the method 100 may be able to determine what devices (e.g., cellular phone, computer, pager or other user device) are associated with the person. In some embodiments, information regarding one or more people or users and/or one or more user devices may be stored in, or accessed from, a user information database and/or a user device information database.

In some embodiments, the step 102 or determining a location associated with a device might be or include one or more of the following: detecting presence of a person carrying or otherwise associated with the device at the location; detecting presence of the device at the location; receiving a notification that a person carrying or otherwise associated with the device is at the location; receiving a notification that the device is at the location; receiving data indicative of the location; receiving data from the device or from a person associated with the device, the data being indicative of the location; receiving a confirmation of the location from the device or a person associated with the device; requesting information regarding the location and/or the device, etc.

In some embodiments, the step 102 or the method 100 may include identifying or otherwise determining a device prior to or as part of determining a location of the device. In some embodiments, determining a device may be or include identifying the device; receiving data indicative of the device; selecting the device from a plurality of devices associated with a person; receiving data indicative of a device being carried by a person; selecting a device based, at least in part, on an attribute of a person carrying or otherwise associated with the device; selecting a device based, at least in part, on an attribute of the device (e.g., storage capacity, bandwidth); selecting a device based, at least in part, on an attribute of a location of the device and/or a location of a person associated with the device; selecting a device based, at least in part, on an attribute of data to be sent to the device; receiving a request or instruction to provide data to a device; selecting a device based, at least in part, on accessibility of the device; etc.

During a step 104, data is determined that is associated with the device and/or one or more people associated with the device. For example, a location of cellular telephone may be determined during the step 102. The cellular telephone may be associated with a specific person. During the step 104, data is identified that is to be provided to the person. In some embodiments, the data may be tailored or related to the specific location determined during the step 102. For example, if the person is conducting business or traveling in New York City, the data may include estimated time until the next subway train arrives at the subway station nearest the person, expected walking time to a client's office, etc. As another example, if the person is hiking in Rocky Mountain National Park in Colorado, the data may include information regarding hunting, camping, boating, fishing, and other regulations specific to that park or information regarding birds or animals of interest to the person. If the person suffers from allergies or asthma, the data may include information regarding pollen counts within the park, pollen zones, etc. The person may be notified when changing pollen zones or areas having different pollen counts. As the person travels from the park into private land, the data may warn the person that no hiking is allowed on the private land. In a third example, a person in a race may receive customized information when on a specific pathway regarding when competitors in the race are expected to pass a certain location, what competitor is leading, etc. Competitors not on the specific pathway would not receive the information. In a further example, a person may request, or be required to receive, certain information or other data when the person is in a specific location. In some embodiments, the person may subscribe to a service that entitles or allows the person to receive data via one or more data perimeters. The person may provide compensation as part of the subscription.

The data determined during the step 104 can be any kind of information, text, graphics, video, audio, rich media, etc. and may be or include, for example, a warning, health information, safety information, information related to or based on a location, a restriction related to a person or other entity, object, etc. in a location, a restriction associated with a location (e.g., a no fly zone, a no smoking area, no trespassing, a no fishing area), a restriction associated with a person (e.g., the specific person is not allowed to enter a building, the specific person is not allowed to be within fifty yards of another person), etc.

In some embodiments, the data may change over time. For example, a person may need to receive current figures regarding availability and price for one or more products as the person visits different customers in a location. As another example, a person may need to receive different information as restrictions for a given area change from weekday to weekend, morning hours to evening hours, etc. In some embodiments, information regarding data may be stored in, or accessed from, a data information database.

Different data may be provided to different devices depending on the capabilities of the devices. For example, a cellular phone may need to receive data in a different format that a wireless personal digital assistant. Different data also may be provided to devices differently depending on availability or accessibility of the devices or a capacity of a communication channel to the devices. For example, a device to which a high bandwidth communication channel is available may receive data in a rich media file while a device to which only a low bandwidth communication channel is available may receive data as a plain text file. Thus, in some embodiments the step 104 or the method 100 may include determining a capability or attribute of a device or of a communication channel to the device.

In some embodiments, the step 104 or determining data associated with a person may be or include one or more of the following: determining the data based, at least in part, on an attribute of the device (e.g., transmission speed, storage capability, display capability, accessibility, access procedure, access code, bandwidth), an attribute of a person (e.g., education, languages spoken, occupation, credit history) associated with the device, the location, a geographic area that includes the location, a data perimeter that covers the location, etc.; receiving the data from an outside source; determining data to be provided to a person when the person is in the location; determining availability of a communication channel to a device in the location; determining capacity of a communication channel to a device in the location; determining data to be provided to a device when the device is in the location; receiving a request or instruction to provide the data to a person when the person is in the location; determining a requirement to provide the data to a person when the person is in the location; receiving a request or instruction to provide the data to the device when the device is in the location; determining a requirement to provide the data to the device when the device is in the location; etc. A request or instruction to provide data to a device or person may come from the device or person or some other device or entity. In some embodiments, the method 100 may include receiving, retrieving, downloading, storing, updating, verifying, maintaining, etc. some or all of the data determined during the step 104.

During a step 106, a plurality of transmitters is determined based, at least in part, on the location. For example, if the location determined during the step 102 is a city and the device is a cellular telephone, the transmitters may be cellular telephone stations located in and/or around the city. If the location determined during the step 102 is a specific city block, the transmitters may be cellular telephone stations within signal transmission and reception range of the city block.

In some embodiments, a transmitter may be or include an apparatus capable of detecting a proximity or a location of a device and/or a person associated with the device; an apparatus capable of transmitting and/or receiving data via a wireless electronic communication; and/or a Bluetooth™ enabled communication device. In some embodiments, one or more of the transmitters may be stationary and/or one or more of the transmitters may be mobile. Also, in some embodiments, one or more transmitters may be temporary and/or one or more transmitters may be permanent. Different transmitters may have different capabilities.

One or more transmitters may form or be part of a data perimeter. In some embodiments, a transmitter may be part of more than one data perimeter. Information regarding transmitters and/or data perimeters may be stored in, or accessed from, a transmitter information database and/or a data perimeter information database. In some embodiments, a device or entity implementing the method 100 may provide information or notice regarding a transmitter and/or a data perimeter.

As previously discussed above, in some embodiments, the data to be provided to a person or device may depend, at least in part, on a capability of the device and/or a communication channel to the device or person. Thus, in some embodiments, the step 106 or the method 100 may include determining how the data should be sent to the person or device, what communication channel should be used to send the data to the person or device, etc.

In some embodiments, step 106 or determining one or more transmitters based on a location may be or include or more of the following: selecting one or more transmitters based, at least in part, on an attribute of a person, device, location, data, transmitter, etc.; determining a plurality of transmitters that are within the location, surround the location, border the location, etc.; determining at least one transmitter that can transmit a signal into a geographic area that includes a specific location; receiving a signal that a device is within range of the at least one transmitter; determining a transmitter based, at least in part, on accessibility, data transfer rate, communication bandwidth, availability, capacity or other attribute of the transmitter; determining a transmitter based, at least in part, on bandwidth of a communication channel to the transmitter; etc.

In some embodiments, the step 106 or the method 100 may include verifying coverage or range of one or more transmitters, verifying that one or more transmitters is within range or covers a location, receiving a confirmation that one or more transmitters is within range or covers a location, receiving a confirmation regarding coverage or range of one or more transmitters, determining a range or coverage area of one or more transmitters, providing a notification of a range or coverage area of one or more transmitters, providing a notification that one or more transmitters is within range or covers a specific location, providing an indication of a location, description, etc. of one or more transmitters, verifying or confirming a boundary, if any, of a location, etc.

During a step 108, some or all of the data determined during the step 104 is provided to one or more of the transmitters determined during the step 106. In some embodiments, the step 108 or providing data to a transmitter may be or include one or more of the following: providing data to a transmitter nearest the location determined during the step 102; providing data to at least one transmitter capable of transmitting the data to the device involved in the step 102; providing an electronic communication that includes the data to one or more of the transmitters, etc.

Data may be provided to a data perimeter or transmitter once, multiple times, continuously, irregularly, periodically, or according to whatever plan or procedure is implemented. In some embodiments, data may be provided to or by a data perimeter or transmitter more than once until an acknowledgement is received that a person, device, transmitter etc. has received the data.

In some embodiments of the method 100 and the other methods disclosed herein, providing data to a data perimeter, transmitter, device, person, etc. may include providing the data directly to the data perimeter, transmitter, device, person, etc. and/or indirectly to the data perimeter, transmitter, device, person, etc. via a device, intermediary, service provider, etc. Thus, during the step 108, providing data to a transmitter may be or include providing the data to a device, intermediary, service provider, communications service (e.g., cellular telephone company, public wireless LAN or other network provider) or other party that will itself provide the data directly or indirectly to the transmitter.

The data provided during the step 108 may be in any form or format, including, but not limited to, a HTTP (Hypertext Transfer Protocol), HTML (Hypertext Mark-up Language) or FTP (File Transfer Protocol) transmission, XML (Extensible Mark-up Language) feed, email message, instant message communication, facsimile or radio transmission, telephone call, wireless signal, electronic signal or communication, etc.

In some embodiments, a device or entity conducting the step 108 or the method 100 may receive an acknowledgement or confirmation of a receipt of the data provided during the step 108. The acknowledgement or confirmation may come from a device or person who received the data or some other entity or device.

In some embodiments, a device or entity implementing some or all of the method 100 may receive compensation for receiving, storing, accessing, maintaining and/or providing data or providing access to or use of a data perimeter, one or more transmitters, etc. Thus, in some embodiments, the method 100 may include receiving compensation receiving compensation for receiving, storing, accessing, maintaining and/or providing data; determining and/or providing a notification of a compensation requirement for receiving, storing, accessing, maintaining and/or providing data; receiving an indication of compensation received; establishing a subscription with a person or device; receiving an indication of a subscription associated with a person or a device (which may be or include establishing a subscription); receiving compensation for a subscription; etc.

In some embodiments, a device or entity implementing the method 100 may receive information regarding the location of a person, transmitter, data perimeter, or device; movement, velocity, etc. of a person or device within, towards or away from a location, data perimeter, transmitter; etc.

In some embodiments, a device or entity implementing the method 100 may receive compensation as a result of one or more of the steps 102, 104, 106 and 108. The method 100 may include determining a compensation amount due and providing a notification regarding the compensation. The compensation may be part of a subscription service set up by a person to receive data.

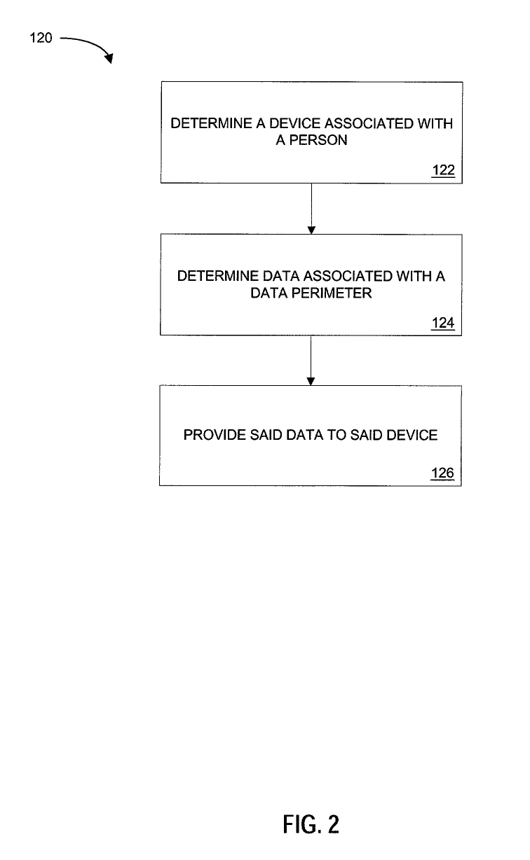

Reference is now made to FIG. 2, where a flow chart 120 is shown which represents the operation of a second embodiment of the present invention. The particular arrangement of elements in the flow chart 120 is not meant to imply a fixed order to the steps; embodiments of the present invention can be practiced in any order that is practicable. In some embodiments, some or all of the steps of the method 120 may be performed or completed by a server, user device and/or another device, as will be discussed in more detail below.

The method 120 is particularly well suited for sending information to a person or device that is related to one or more data perimeters covering the person or device. For example, a person may be traveling in multiple countries. As a person enters a new country or location within a country, a central service, device or entity implementing the method 100 may identify information regarding one or more data perimeters that the person may come into contact with, or that may fall within reception range of a device carried by the person. The central service, device or entity may send information regarding the data perimeter(s) to the device, which may then display some or all of the information to the person as necessary (e.g., as the person enters, leaves, or nears a data perimeter).

Processing begins at a step 122 during which a device associated with a person is determined. A person may have more than one device associated with him or her and the step 122 may include selecting from among multiple devices. Selection of a device may be based on an attribute (e.g., storage capacity, bandwidth) of the device, availability or accessibility of the device (e.g., is it easier to reach the person via a pager or via a cellular telephone), the location of the device and/or person, etc. The person may indicate (e.g., send an email message or radio signal) the device to be used, the location of the device or person, etc. In some embodiments, a device may send out a signal regarding or identifying its location.

The device identified during the step 122 may be carried by the person, travel with the person, or be reachable by the person via a communication network. In some embodiments, the step 122 or the method 100 may include determining the location of a device or a person associated with the device.

During a step 124, data perimeter information that is to be provided to the person via the device identified during the step 122 is determined. In some embodiments, the data perimeter information determined during the step 124 may be or include information regarding a location, capability, range, frequency, accessibility, availability, bandwidth, electronic address, access code or procedure, or other attribute of the data perimeter and/or a transmitter or other device included in the data perimeter; information regarding a geographic area covered by the data perimeter and/or a transmitter in the data perimeter; information regarding an object, individual, building, vehicle, etc. within a geographic area covered by the data perimeter; etc.

In some embodiments, the step 124 or the method 120 may include identifying or otherwise determining a data perimeter. The data perimeter may be one that covers a geographic area in which the device determined during the step 122 is located or a person associated with the device is located. Alternatively, the data perimeter may be one that is near or that covers a location where the device is expected to be or will be in the future. The data perimeter may be selected based on an attribute of the data perimeter, the device, etc. and/or the ability of the data perimeter to communicate with the device.

In some embodiments, the step 124 or determining data perimeter information associated with a person or device may be or include one or more of the following: determining a data perimeter that covers a location of the person or device; determining data associated with the person regarding a data perimeter that covers a location of the person or device; determining data to be provided to the device via the data perimeter when the device or person is in the location; determining information regarding a location of the data perimeter or a transmitter included in the data perimeter; determining information regarding a geographic area covered by the data perimeter or a transmitter in the data perimeter; determining information regarding an object, individual, building, vehicle, etc. within a geographic area covered by the data perimeter or a transmitter included in the data perimeter; etc.

During a step 126, the data determined during the step 124 is provided to the device determined during the step 122. The data may be provided directly or indirectly to the device, as previously discussed above. The step 124 is similar to the step 108 previously discussed above.

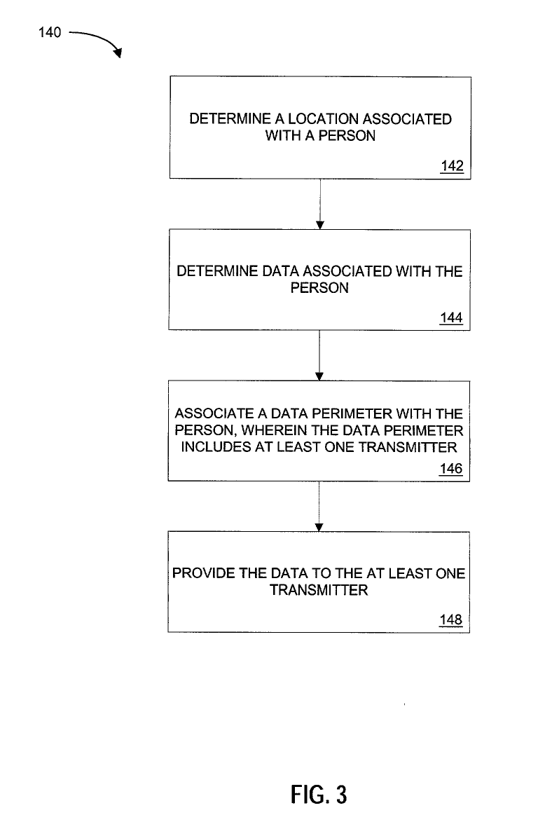

Reference is now made to FIG. 3, where a flow chart 140 is shown which represents the operation of a third embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below. In some embodiments, the method 140 may include some or all of the variations discussed above with regard to the method 100 or the other methods disclosed herein.

The method 140 is particularly suited for providing information to or about a person via a data perimeter where the information is related to the person, the person's location, etc. For example, a person may be wearing an artificial heart, pacemaker, or other medical device. The person may want others to know that use of certain frequencies by radios, telephones, etc. may interfere with the person's device. As another example, the person may need to receive a reminder to take medication, change medication, adjust the pacemaker, etc. The method 140 may be used to determine the location of the person, what information should be provided to or about the person while the person is at the location, and what data perimeter is available to cover the location. The information can then be provided to the appropriate data perimeter.

Processing begins at a step 142 during which a location associated with a person is determined. The location may be a geographic area or point where the person currently is or will be in the future or any type of location as previously discussed above. The step 142 is similar to the step 102.

In some embodiments, the step 142 or determining a location associated with a person may be or include one or more of the following: detecting presence or proximity of the person at the location; detecting presence or proximity of a device associated with the person at the location; receiving a notification that the person is at the location; receiving information regarding the location from the person or a device associated with the person; receiving a notification that a device associated with the person is at the location; receiving data indicative of the location; receiving data from the person, the data being indicative of the location; receiving data from a device associated with the person, the data being indicative of the location; receiving a confirmation of the location from the person; requesting information regarding the location, etc.

During a step 144, data associated with the person is determined. The step 144 is similar to the step 104 previously discussed above. In some embodiments, the person may subscribe to a service that entitles or allows the person to receive and/or transmit data via one or more data perimeters.

During a step 146, a data perimeter is associated with the person, preferably wherein a data perimeter includes one more transmitters. The step 146 is similar to the step 106 previously discussed above. In some embodiments, a data perimeter may include one or more transmitters that are in or that border a location, one or more transmitters that cover a location, and/or one or more transmitters that are within range of a location. In some embodiments, a transmitter and/or data perimeter may cover more or less geographic area than a location determined during the step 142. Thus, the range or coverage area of a data perimeter or transmitter may not exactly align with a geographic location. In some embodiments, a data perimeter may form or be part of a physical barrier (e.g., a fence, moat) that surrounds a given location. In some embodiments, a data perimeter may include one or more mobile transmitters and/or one or more stationary transmitters.

In some embodiments, the step 146 or associating a data perimeter with a person may be or include one or more of the following: determining at least one transmitter within the location determined during the step 142; determining at least two transmitters that border the location determined during the step 142; determining at least one transmitter that can transmit a signal into a geographic area that includes the location determined during the step 142; determining at least three transmitters that from a boundary around the location determined during the step 142; selecting at least one transmitter based, at least in part, on a attribute of the person involved in the step 142, an attribute of the at least one transmitter, an attribute of the location determined during the step 142, an attribute of the data determined during the step 144, and/or an attribute of a device associated with the person involved in the step 142; receiving a signal that a person or a device associated with a person is within range of the at least one transmitter; determining at least one transmitter based, at least in part, on accessibility, availability, data transfer rate, storage capacity, communication bandwidth, etc. of the at least one transmitter; etc.

During a step 148, the data determined during the step 144 is provided to at least one transmitter identified or otherwise determined during the step 146. The step 148 is similar to the step 108 previously discussed above. In some embodiments, the step 148 or providing data to a transmitter may include one or more of the following: providing the data to a transmitter nearest the location determined during the step 142; providing the data to at least one transmitter that can transmit a signal into a geographic area that includes the location determined during the step 142; providing the data to at least one transmitter capable of transmitting the data to a device associated with the person; providing an electronic communication that includes the data to the at least one of a plurality of transmitters; providing the data to a device that controls one or more of the transmitters identified during the step 146; etc.

In some embodiments, the method 140 may include providing a description of a data perimeter; receiving, retrieving, downloading, storing, maintaining, updating, etc. data; receiving compensation for receiving, retrieving, downloading, storing, maintaining, updating, etc. data; or some or all of the variations discussed above in relation to the method 100.

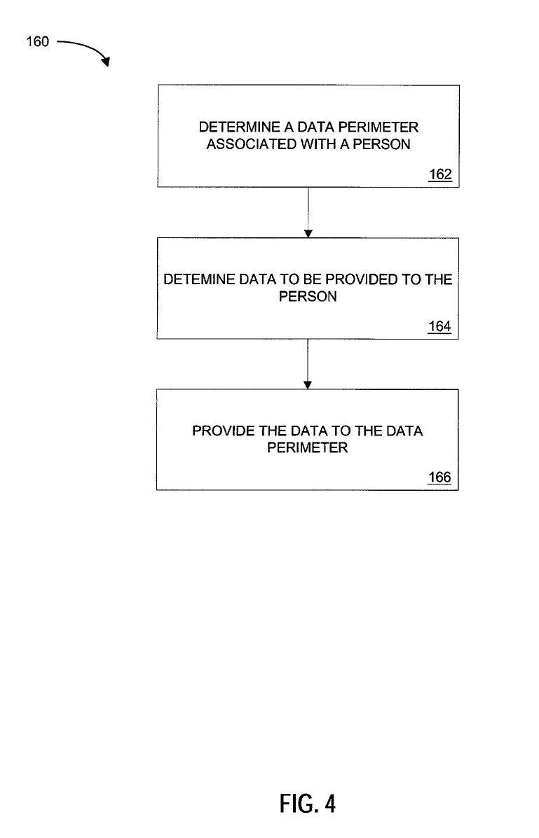

Reference is now made to FIG. 4, where a flow chart 160 is shown which represents the operation of a fourth embodiment of the present invention. The particular arrangement of elements in the flow chart 160 is not meant to imply a fixed order to the steps; embodiments of the present invention can be practiced in any order that is practicable. In some embodiments, some or all of the steps of the method 160 may be performed or completed by a server, user device and/or another device, as will be discussed in more detail below. In some embodiments, the method 160 may include some or all of the variations discussed above with regard to the methods 100, 120 and/or 140 or the other methods disclosed herein. The method 160 is particularly suited for use in providing information via a data perimeter to one or more people.

Processing begins at a step 162 during which a data perimeter associated with a person is determined. As previously discussed above, in some embodiments, a data perimeter may include one or more transmitters, some or all of which may be mobile, stationary, temporary, permanent, etc.

In some embodiments, the step 162 or determining a data perimeter may be or include one or more of the following: receiving an indication of a data perimeter; receiving a request to establish a specific data perimeter; determining at least one transmitter associated with or proximate to a location associated with a person or a device associated with the person; determining at least two transmitters that border a location associated with a person or a device associated with the person; determining at least three transmitters that from a boundary around a location associated with a person or a device associated with the person; determining at least one transmitter that can transmit a signal into a geographic area that includes a; selecting at least one transmitter based, at least in part, on a attribute of a person, an attribute of a location, an attribute of one or more transmitters, an attribute of data associated with a person, etc.; receiving a signal that a device associated with a person is within range of at least one transmitter; selecting or otherwise determining at least one transmitter based, at least in part, on accessibility, availability, storage capacity, communication bandwidth, data transfer rate, etc. of the at least one transmitter; etc.

During a step 164, data to be provided to the person involved in the step 162 is determined. The step 164 is similar to the steps 104 and 144 previously discussed above. In some embodiments, the person may subscribe to a service that entitles or allows the person to receive data via one or more data perimeters.

During a step 166, the data determined during the step 164 is provided to the data perimeter determined during the step 162. The step 166 is similar to the steps 108 and 148 previously discussed above. In some embodiments, the step 166 or providing data to a data perimeter may be or include one or more of the following: providing the data to a transmitter nearest a location of the person or a device associated with the person; providing the data to at least one transmitter that can transmit a signal into a geographic area that includes a location of the person or a device associated with the person; providing the data to a transmitter capable of transmitting the data to a device associated with the person; providing an electronic communication that includes the data to the data perimeter; providing an electronic communication that includes the data to at least one transmitter in the data perimeter; etc.

In some embodiments, the method 160 may include providing a description of a data perimeter; receiving, retrieving, downloading, storing, maintaining, updating, etc. data; receiving compensation for receiving, retrieving, downloading, storing, maintaining, updating, etc. data; or some or all of the variations discussed above in relation to the methods 100, 120, and 140.

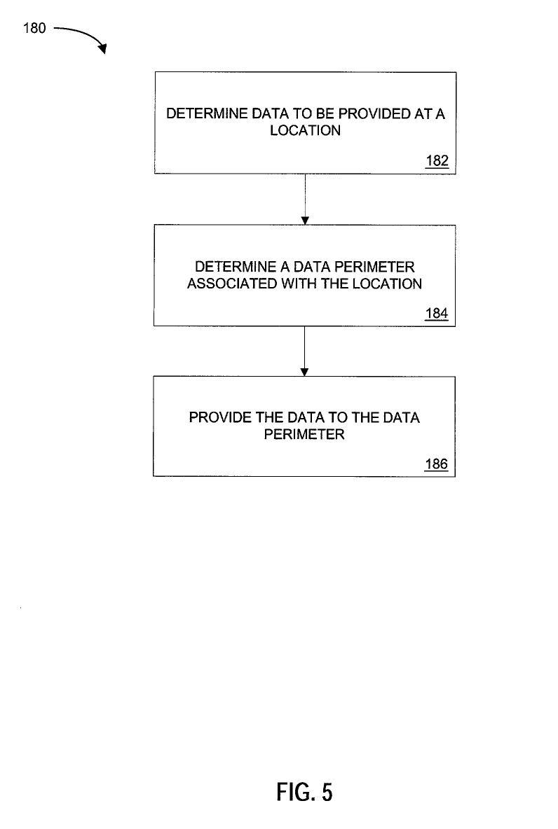

Reference is now made to FIG. 5, where a flow chart 180 is shown which represents the operation of a fifth embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below. In some embodiments, the method 180 may include some or all of the variations discussed above with regard to the methods 100, 120, 140 and/or 160.

Processing begins at a step 182 during which data to be provided at a location is identified or otherwise determined. In some embodiments, a location may include a set of locations, such as a boundary perimeter of an estate or the perimeter of a campus. In some embodiments of the method 180, the data determined during the step 182 might not be associated with a particular person, group of people, device, etc. For example, the data may be or include a warning not to trespass near an airport, a warning not to interfere with people working at or entering a nuclear power plant, information relating restrictions in a national park, information relating to an individual of importance (e.g., U.S. President), etc.

In some embodiments, the step 182 or determining data to be provided at a location may be or include one or more of the following: determining data associated with a person at the location; determining data associated with a device at the location; receiving a request or instruction to provide the data to a person or a device at the location; etc.

During a step 184, a data perimeter is determined that is associated with the location determined during the step 182. As previously discussed above, a data perimeter may include one or more stationary or mobile transmitters. In some embodiments the step 184 may occur prior to or simultaneous with the step 182.

In some embodiments, the step 184 or determining a data perimeter associated with a location may be or include one or more of the following: receiving an indication of the data perimeter; determining at least one transmitter within the location; determining at least two transmitters that border the location; determining at least three transmitters that from a boundary around the location; determining at least one transmitter that can transmit a signal into a geographic area that includes the location; selecting at least one transmitter based, at least in part, on an attribute of a person at the location; selecting at least one transmitter based, at least in part, on a attribute of the location; selecting at least one transmitter based, at least in part, on a attribute of the at least one transmitter; selecting at least one transmitter based, at least in part, on a attribute of the data determined during the step 182; selecting at least one transmitter based, at least in part, on a attribute of a device at the location; receiving a signal that a device associated with a person who is within range of the at least one transmitter; determining at least one of a plurality of transmitters based, at least in part, on accessibility, bandwidth, storage capacity, etc. of the transmitter; etc.

During a step 186, some or all of the data determined during the step 182 is provided to the data perimeter determined during the step 184. The step 186 is similar to the steps 108, 148 and 166 previously discussed above.

In some embodiments, the method 180 may include providing a description of a data perimeter; receiving, retrieving, downloading, storing, maintaining, updating, etc. data; receiving compensation for receiving, retrieving, downloading, storing, maintaining, updating, etc. data; receiving compensation for all or some of the steps of the method 180; or some or all of the variations discussed above in relation to the methods 100, 140 and 160.

System

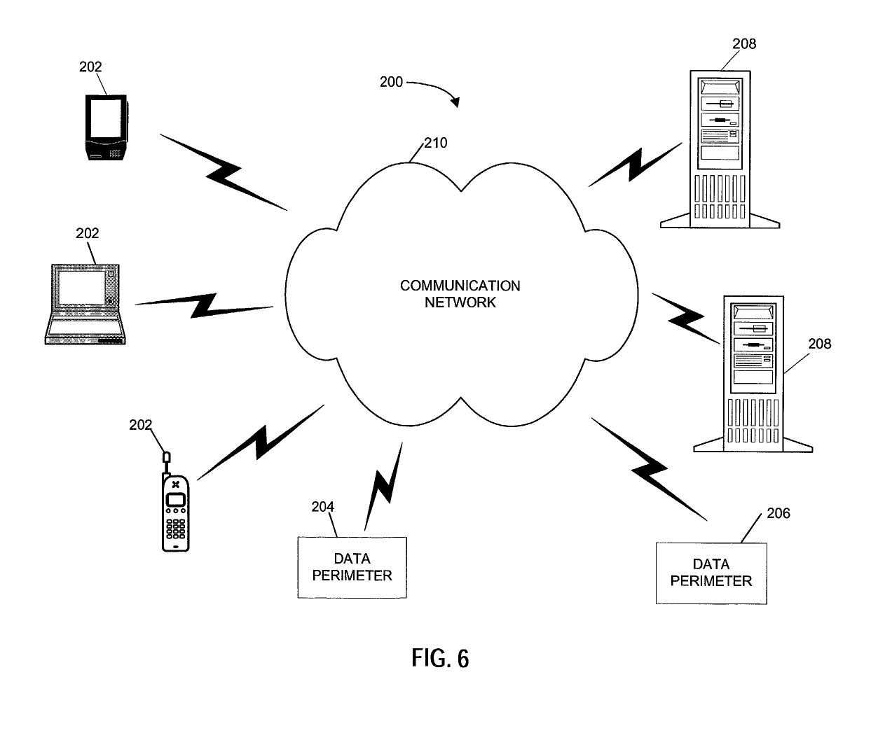

Now referring to FIG. 6, an apparatus or system 200 usable with the methods disclosed herein is illustrated. The apparatus 200 includes one or more user or client devices 202 that may communicate directly or indirectly with one or more data perimeters 204, 206 and/or one or more servers, controllers or other devices 208 via a computer, data, or communications network 210. In some embodiments, the methods described herein may use one or more existing transmitters or one or more transmitters that are used for other purposes (e.g., radio broadcasting, emergency signal broadcasting).

In some embodiments, a server 208 may implement or host a Web site. A server 208 can comprise a single device or computer, a networked set or group of devices or computers, a workstation, etc. In some embodiments, a server 208 also may function as a database server and/or as a user device. The use, configuration and operation of servers will be discussed in more detail below.

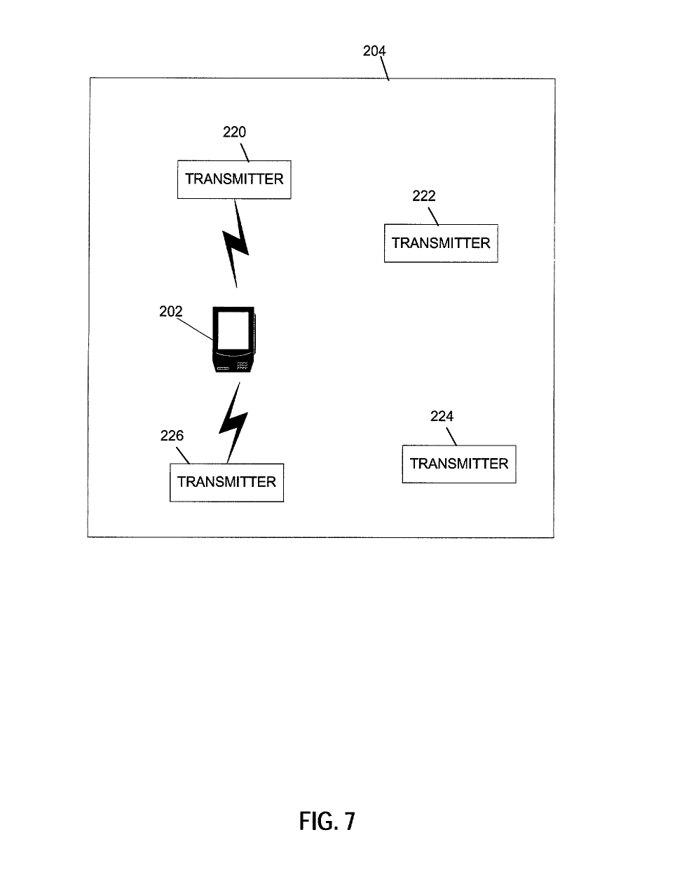

A data perimeter may include one or more transmitters that can communicate with one or more user devices 202, as illustrated in FIG. 7. As illustrated by the data perimeter 204 of FIG. 7, the data perimeter 204 includes four transmitters 220, 222, 224, 226, two of which are within range and/or communicating with the user device 202. In some embodiments, a transmitter may be in direct contact or communication with one or more servers 208. In other embodiments some or all of the transmitters for a data perimeter may be connected to or in communication with an intermediary device that is in contact or communication with one or more servers 208. In some embodiments, a transmitter may be used or associated with more than one data perimeter. In addition, a transmitter may be used to communicate with more than one user device, user, etc. Furthermore, one or more transmitters may be associated with disparate networks (e.g., one transmitter is associated with a cellular telephone network, one with a radio network, one with a local area network, etc.).

Referring again to FIG. 6 the user or client devices 202 preferably allow entities to interact with the servers 208 and the remainder of the apparatus 200 and receive data from data perimeters and send data to data perimeters. The user devices 202 also may enable a user to access Web sites, software, databases, etc. hosted or operated by the servers 208 or other devices. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database. In some embodiments, devices may receive information from one or more transmitters or a data perimeter and use the information to locate additional information or sources of information. For example, a device may receive information regarding the weather associated with a particular location. The information may include data (e.g., URL, link, radio frequency, television frequency) regarding a location (e.g., radio station, Web page, television channel) that the device can be directed or tuned to in order to receive additional information. The device may include software or other capability to detect the data and direct or tune the device to the proper location.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 6 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device, transmitter or data perimeter may be connected directly to a server 208 without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 6 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204.

Although three user devices 202 and two data perimeters 204, 206 and two servers 2084 are shown in FIG. 6, any number of such devices may be included in the system 200. The devices shown in FIG. 6 need not be in constant communication. For example, a user device may communicate with a server and/or a transmitter or data perimeter only when such communication is appropriate or necessary.

Server

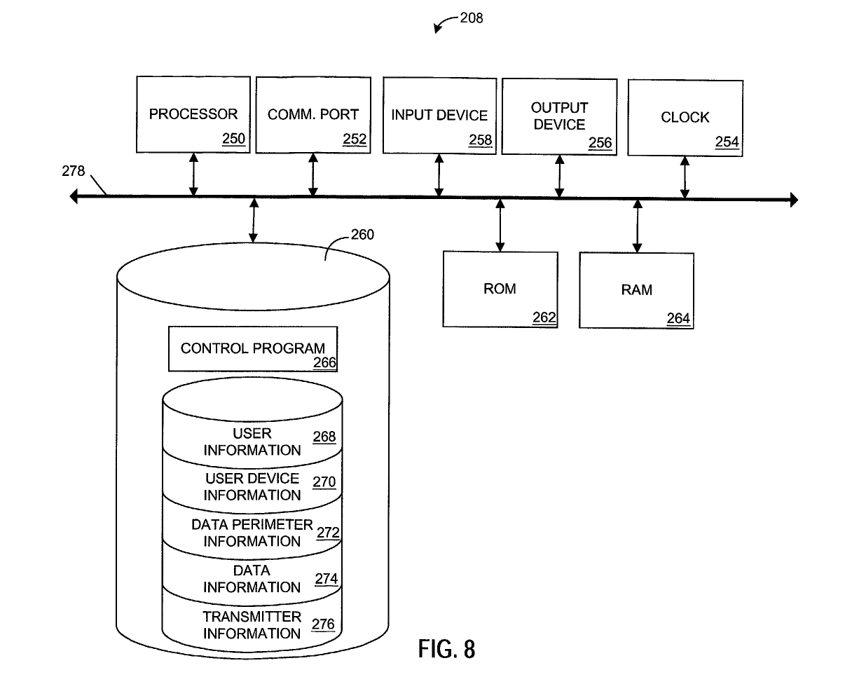

Now referring to FIG. 8, a representative block diagram of a server or controller 208 is illustrated. The server 208 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 208 also may include an internal clock element 254 to maintain an accurate time and date for the server 208, create time stamps for communications received or sent by the server 208, etc. In some embodiments, the server 208 might be in direct communication with one or more transmitters. Alternatively, or in conjunction, in some embodiments the server 208 might communicate with one or more transmitters indirectly (e.g., via an intermediary device or transmitter controller).

If desired, the server 208 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 208 may include a memory or data storage device 260 to store information, software, databases, communications, device drivers, data, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 208 also may include separate ROM 262 and RAM 264.

The processor 250 and the data storage device 260 in the server 208 each may be, for example: (i) located entirely within a single computer or other computing device; or (ii) connected to each other by a remote communication medium, such as a serial port cable, telephone line or radio frequency transceiver. In one embodiment, the server 208 may comprise one or more computers that are connected to a remote server computer for maintaining databases.

A conventional personal computer or workstation with sufficient memory and processing capability may be used as the server 208. In one embodiment, the server 208 operates as or includes a Web server for an Internet environment. The server 208 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 208. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 208 also may include or store information regarding users, user devices, transmitters, data perimeters, data providers, data sets, locations, communications, etc. For example, information regarding one or more users may be stored in a user information database 268 for use by the server 208 or another device or entity. Information regarding one or more user devices may be stored in a user device information database 270 for use by the server 208 or another device or entity. Information regarding one or more data perimeters may be stored in a data perimeter information database 272 for use by the server 208 or another device or entity. Information regarding one or more groups, sets, collections, streams, etc. of data may be stored in a data information database 274. Information regarding one or more transmitters may be stored in a transmitter information database 276 for use by the server 208 or another device or entity. In some embodiments, some or all of one or more of the databases may be stored remotely from the server 208.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 278.

While specific implementations and hardware configurations for servers 204 have been illustrated, it should be noted that other implementations and hardware configurations are possible and that no specific implementation or hardware configuration is needed. Thus, not all of the components illustrated in FIG. 8 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, television, etc. If desired, the user device 202 also may function as a server 208 and/or as another device. In some embodiments, a user device 202 may have the same structure or configuration as the server 208 illustrated in FIG. 8 and include some or all of the components of the server 208.

Databases

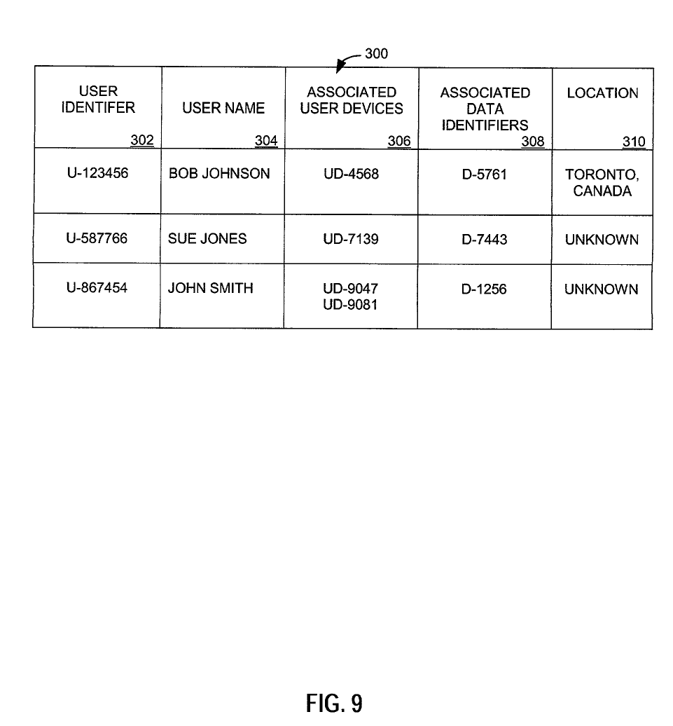

As previously discussed above, in some embodiments a server, user device, or other device may include or access a user information database for storing or keeping information regarding one or more users. One representative user information database 300 is illustrated in FIG. 9.

The user information database 300 may include a user identifier field 302 that may include codes or other identifiers for one or more users, a user name field 304 that may include a name or other descriptive or contact information for a user identified in the field 302, an associated user device identifier field 306 that may include codes or other identifiers for one or more devices associated with one or more of the users identified in the field 302, an associated data identifier field 308 that may include codes or other identifiers for data that is associated with one or more of the users identified in the field 302, and a user location field 310 that may include information regarding a location of a user identified in the field 302. As another example, the database 300 may include information regarding a preferred network, data perimeter or transmitter for communication associated with one or more users. In some embodiments, information regarding a user device might be found in a user device information database and information regarding data might be found in a data information database. A user may be associated with more than one user device, and vice versa. Similarly, a user may be associated with more than one set of data or data perimeter, and vice versa.

Other or different fields also may be used in the user information database 300. For example, in some embodiments a data information database may include a data perimeter identifier field that may include a code or other identifier for a data perimeter or transmitter that is in range of a user identified in the field 302 or is associated with the user device identified in the field 306, the data identified in the field 308 and/or the location identified in the field 310. As another example, in some embodiments, a user information database might include a field that includes information (e.g., telephone number, email address, IP address) regarding how to contact or communication with a user identified in the field 302 via a user device identified in the field 306 and/or a field that includes information regarding how a location of user was or is to be determined.

As illustrated in the user information database 300 of FIG. 9, the user identified as “U-123456” in the field 302 is named “BOB JOHNSON” and is associated with a user device identified as “UD-4568”. The user identified as “BOB JOHNSON” is associated with the data identified as “D-5761” and is currently located in “TORONTO, CANADA”. As indicated by the entries in the field 310 for the users identified as “U587766” and “U-867454”, their location currently is “UNKNOWN.”

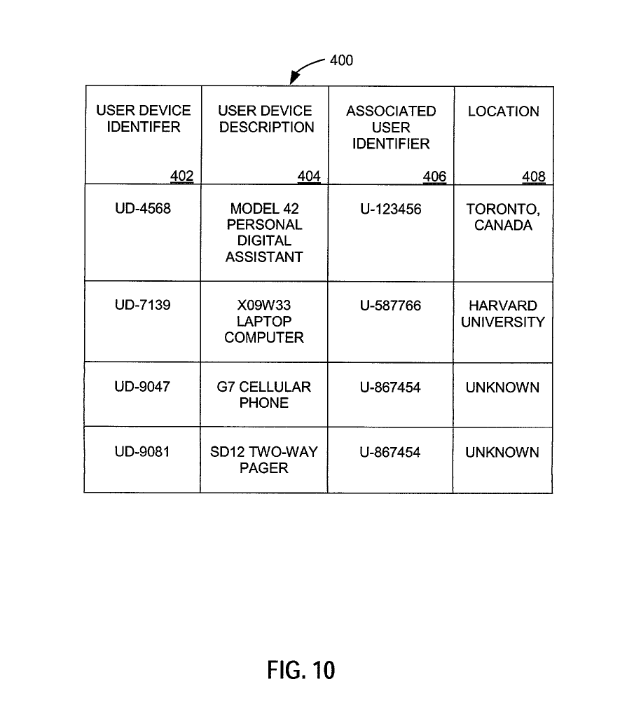

As previously discussed above, in some embodiments a server, user device, or other device may include or access a user device information database for storing or keeping information regarding one or more user devices. One representative user device information database 400 is illustrated in FIG. 10.

The user device information database 400 may include a user device identifier field 402 that includes codes or other identifiers for one or more user devices, a user device description field 404 that may include descriptions and other information regarding the user devices identified in the field 402, an associated user identifier field 406 that may include codes or other identifiers for one or more users associated with the user devices identified in the field 402, and a location field 408 that may include information regarding the locations of the user devices identified in the field 402. A user device may be associated with more than one user, and vice versa.

Other or different fields also may be used in the user device information database 400. For example, in some embodiments a user device information database may include a field that includes information (e.g., email address, telephone number) regarding how to contact or communicate with a user or user device.

As illustrated by the user device information database 400 of FIG. 10, the user device identified as “UD-4568” is a “MODEL 42 PERSONAL DIGITAL ASSISTANT” and is associated with the user identified as “U-123456”. The user device identified as “UD-4568” is currently located in “TORONTO, CANADA”. Note that in some embodiments or circumstances, a location of a user and a device associated with the user might both be known or both unknown. In addition, in some embodiments or circumstances, a location of a user might be known while a location of a user device associated with the user might not be known, and vice versa.

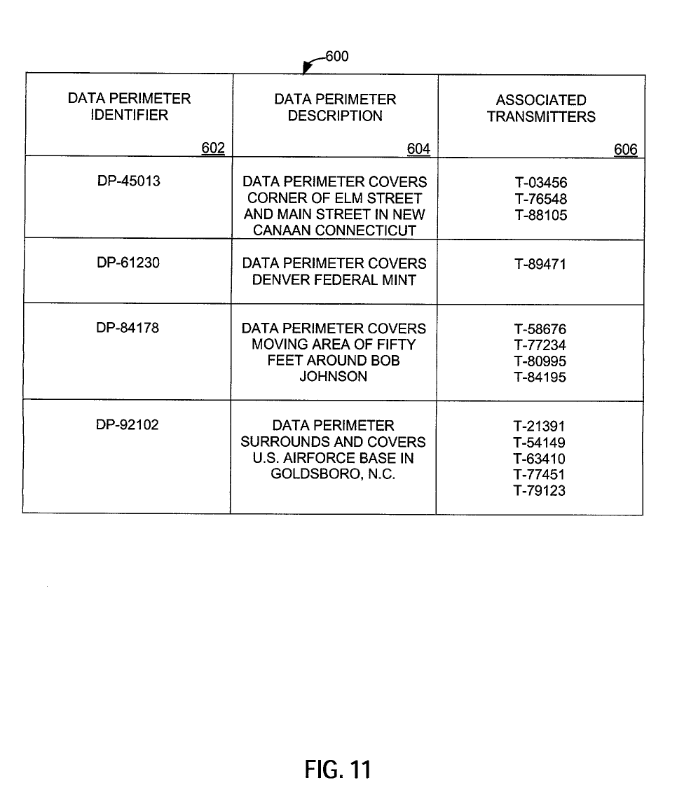

As previously discussed above, in some embodiments a server, user device, or other device may include or access a data perimeter database for storing or keeping information regarding one or more data perimeters. One representative data perimeter database 600 is illustrated in FIG. 11.

The data perimeter database 600 may include a data perimeter identifier field 602 that may include codes or other identifiers for one or more data perimeters, a data perimeter description field 604 that may include descriptions and other information related to the data perimeters identified in the field 602, and an associated transmitters field 606 that may include codes or other identifiers for one or more transmitters associated with the data perimeters identified in the field 602. Other or different fields also may be used in the data perimeter database 600. For example, in some embodiments a data perimeter information database may include a field that includes information regarding how to contact or communicate with a data perimeter or a transmitter, a field that includes information regarding availability, bandwidth, or other attribute of a data perimeter or transmitter, etc.

As illustrated by the data perimeter information database 600 of FIG. 11, the data perimeter identified as “DP-45013” in the field 602 covers the corner of Elm Street and Main Street in New Canaan Conn. and includes or is associated with the transmitters identified as “T-03456”, “T-76548” and “T-88105”. A data perimeter may be associated with one or more transmitters and a transmitter may be associated with one or more data perimeters. In some embodiments, information regarding one or more transmitters might be stored in, or accessed from, a transmitter information database. In some embodiments, a centralized service (such as a cellular telephone company) may provide additional transmitters. That is, data transmission to a device may be accomplished by an intermediary of the cellular telephone company.

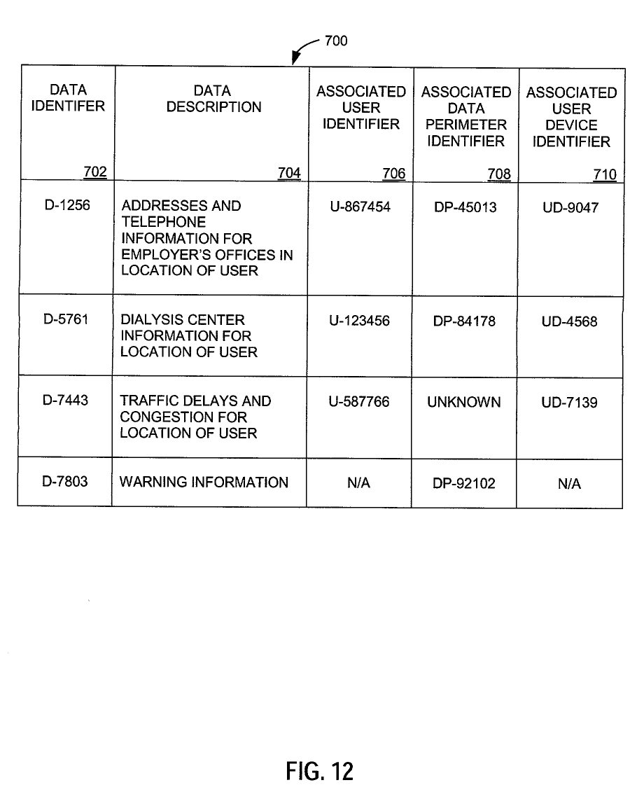

As previously discussed above, in some embodiments a server, user device, or other device may include or access a data information database for storing or keeping information regarding data to be provided to one or more users, data perimeters, locations, devices, etc. One representative data information database 700 is illustrated in FIG. 12.

The data information database 700 may include a data identifier field 702 that may include codes or other identifiers for different groups, sets, streams, etc. of data, a data description field 704 that may include descriptions and other information regarding the data identified in the field 704, an associated user identifier field 706 that may include codes or other identifiers for one or more users, if any, associated with the data identified in the field 702, an associated data perimeter identifier field 708 that may include codes or other identifiers for one or more data perimeters, if any, associated with the data identified in the field 702, and an associated user device identifier field 710 that may include codes or other identifiers for one or more user devices, if any, associated with the data identified in the field 702. Data may be associated with one or more users, one or more user devices and one or more data perimeters, and vice versa. Other or different fields also may be used in the data information database 700. For example, in some embodiments a data information database might include a field that provides information regarding the currency of the data identified in the field 702, a field that includes information regarding where the data identified in the field 702 came from, a field that includes information regarding when data identified in the field 702 was provided to a user, user device and/or data perimeter, etc.

As illustrated by the data information database 700 of FIG. 12, the data identified as “D-1256” in the field 702 includes “ADDRESSES AND TELEPHONE NUMBERS FOR EMPLOYER'S OFFICES IN THE LOCATION OF USER” and is associated with the user identified as “U-8867454”, the user device identified as “UD9047” and the data perimeter identified as “DP-45013”. Presumably, the data identified as “D-1256” was transmitted via the data perimeter “DP-45013” to the user “U-867454” and/or the user device “UD-9047”.

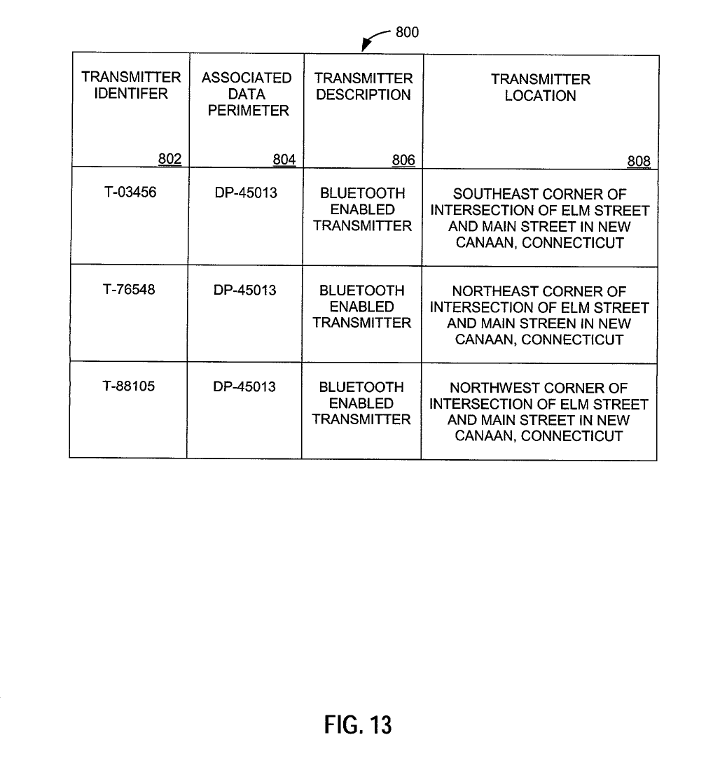

As previously discussed above, in some embodiments a server, user device, or other device may include or access a transmitter information database for storing or keeping information regarding one or more transmitters. One representative transmitter information database 800 is illustrated in FIG. 13.

The transmitter information database 800 may include a transmitter identifier field 802 that may include codes or other identifiers for one or more transmitters, an associated data perimeter identifier field 804 that may include codes or other identifiers for one or more data perimeters associated with each transmitter identified in the field 802, a transmitter description field 806 that may include descriptions and other information (e.g., bandwidth, availability, range) regarding the transmitters identified in the field 802, and a transmitter location field 808 that may include location information (e.g., GPS coordinate, street intersection, latitude and longitude) for the transmitters identified in the field 802. Other or different fields also may be used in the transmitter information database 800. A transmitter may be associated with more than one data perimeter, and vice versa. Thus, in some embodiments, a transmitter information database may associate transmitters with locations of the transmitters. Alternatively, a transmitter information database may describe a set of data perimeters defined by location and then a way to select the transmitters for a given location based on a description of the location.

As illustrated by the transmitter information database 800 of FIG. 13, the transmitter identified as “T-03456” in the field 802 is associated with the data perimeter identified as “DP-45013” and is a “BLUETOOTH ENABLED TRANSMITTER”. The transmitter identified as “T-03456” is located at the “SOUTHEAST CORNER OF ELM STREET AND MAIN STREET IN NEW CANAAN, CONNECTICUT”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to several embodiments, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating delivery of data, comprising:
determining a location associated with a device, wherein said device is associated with a person;
determining data associated with said person;
determining a plurality of transmitters based, at least in part, on said location, wherein at least one of said plurality of transmitters is capable of transmitting data via a wireless signal to said device; and
providing said data associated with said person to at least one of said plurality of transmitters.

2. The method of claim 1, wherein said determining a location associated with a device, wherein said device is associated with a person, includes at least one of the following:
detecting presence of said person at said location;
detecting presence of said device at said location;
receiving a notification that said person is at said location;
receiving a notification that said device is at said location;
receiving data indicative of said location;
receiving data from said person, said data being indicative of said location;
receiving data from said device, said data being indicative of said location;
receiving a confirmation of said location from said device;
receiving a confirmation of said location from said person; and
requesting information regarding said location.

3. The method of claim 1, wherein said determining data associated with said person includes at least one of the following:
determining a communication channel to said device;
determining said data based, at least in part, on an attribute of said device;
determining said data based, at least in part, on said location;
determining said data based, at least in part, on a geographic area that includes said location; and
determining said data based, at least in part, on a data perimeter that covers said location.

4. The method of claim 1, wherein said determining data associated with said person includes at least one of the following:
determining said data based, at least in part, on an attribute of said person.
determining data to be provided to said person when said person is in said location;
determining data to be provided to said device when said device is in said location;
receiving a request to provide said data to said person when said person is in said location;
receiving an instruction to provide said data to said person when said person is in said location;
determining a requirement to provide said data to said person when said person is in said location;
receiving a request to provide said data to said device when said device is in said location;
receiving an instruction to provide said data to said device when said device is in said location; and
determining a requirement to provide said data to said device when said device is in said location.

5. The method of claim 1, wherein said determining a plurality of transmitters based, at least in part, on said location, wherein at least one of said plurality of transmitters is capable of transmitting data via a wireless signal to said device includes at least one of the following:
selecting said plurality of transmitters based, at least in part, on an attribute of said person;
selecting said plurality of transmitters based, at least in part, on an attribute of said device;
selecting said plurality of transmitters based, at least in part, on an attribute of said location;
selecting said plurality of transmitters based, at least in part, on an attribute of said data;
selecting said plurality of transmitters based, at least in part, on an attribute of at least one of said plurality of transmitters;
selecting at least one of said plurality of transmitters based, at least in part, on an attribute of said person;
selecting at least one of said plurality of transmitters based, at least in part, on an attribute of said device;
selecting at least one of said plurality of transmitters based, at least in part, on an attribute of said location;
selecting at least one of said plurality of transmitters based, at least in part, on an attribute of said data;
selecting at least one of said plurality of transmitters based, at least in part, on an attribute of said at least one of said plurality of transmitters;
determining a plurality of transmitters that are within said location;
determining a plurality of transmitters that surround said location;
determining a plurality of transmitters that border said location;
determining at least one transmitter that can transmit said signal into a geographic area that includes said location;
receiving a signal that said device is within range of said at least one of said plurality of transmitters;
determining at least one of said plurality of transmitters based, at least in part, on accessibility of said at least one of said plurality of transmitters;
determining at least one of said plurality of transmitters based, at least in part, on data transfer rate of said at least one of said plurality of transmitters;
determining at least one of said plurality of transmitters based, at least in part, on availability of said at least one of said plurality of transmitters; and
determining at least one of said plurality of transmitters based, at least in part, on bandwidth of a communication channel to said at least one of said plurality of transmitters.

6. The method of claim 1, wherein said providing said data associated with said person to at least one of said plurality of transmitters includes at least one of the following:
providing said data to a transmitter nearest said location;
providing said data to a transmitter capable of transmitting said data to said device;
providing said data to a communications service; and
providing an electronic communication that includes said data to said at least one of said plurality of transmitters.

7. The method of claim 1, further comprising:
receiving a request to provide said data to said person.

8. The method of claim 7, wherein said request is received from one of the following:
said person; and
an owner of said data.

9. The method of claim 1, further comprising:
determining said device.

10. The method of claim 1, wherein at least one of said plurality of transmitters is mobile.

11. The method of claim 1, wherein at least one of said plurality of transmitters is stationary.

12. The method of claim 1, wherein at least one of said plurality of transmitters comprises at least one of the following:
an apparatus capable of detecting a location of said device;
an apparatus capable of detecting proximity of said device;
an apparatus capable of transmitting said data via an electronic communication;
an apparatus capable of receiving said data via an electronic communication; and
a Bluetooth™ enabled communication device.

13. The method of claim 1, wherein said data associated with said person includes at least one of the following:
a warning;
health information;
safety information;
information related to said location;
a restriction related to an entity in said location;
a restriction related to an object in said location;
a restriction associated with said location;
a restriction associated with said person;
data associated with a preference associated with said person;
data associated with subscription information associated with said person; and
data associated with profile information associated with said person.

14. The method of claim 1, further comprising:
receiving compensation for said providing said data.

15. The method of claim 1, wherein said data changes from a first time to a second time.

16. The method of claim 1, wherein said data is based, at least in part, on said location.

17. The method of claim 1, further comprising:
receiving said data.

18. The method of claim 1, further comprising:
providing to a first party an acknowledgement of a receipt of said data by a second party.

19. The method of claim 1, where in said location is at least one of the following:
a geographic area;
a city;
a country;
a building;
a geographic area surrounding a building;
a parcel of land;
a boundary of a geographic area;
a portion of a city;
a portion of a country;
a portion of a building;
a restricted area;
a specific point of longitude and latitude;
a specific GPS point;
a location of an individual;
a location of said person;
a location of a vehicle;
a location of an object;
an area within a designated distance from an individual;
an area within a designated distance from a vehicle;
an area within a designated distance from an object;
an area within a designated distance from a specific longitude and latitude;
an area within a designated distance from a specific GPS point;
an area within a designated distance from a range of GPS points;
a geographic area surrounding an individual;
a geographic area surrounding a vehicle;
a geographic area surrounding an object;
a geographic area surrounding a specific longitude and latitude;
a geographic area having a designated profile; and
a geographic area surrounding a specific GPS point.

20. The method of claim 1, further comprising at least one of the following:
providing an indication of a location of at least one of said plurality of transmitters;
providing an indication of a description of a data perimeter, wherein said data perimeter includes at least one of said plurality of transmitters;
receiving an indication of a description of a data perimeter;
verifying that said plurality of transmitters covers said location;
receiving confirmation that said plurality of transmitters covers said location; and
determining a range of coverage provided by at least one of said plurality of transmitters.

21. The method of claim 1, wherein said location is movable.

22. The method of claim 1, wherein said location is fixed.

23. The method of claim 1, wherein said location has a boundary that is movable.

24. The method of claim 1, wherein said location has a boundary that is fixed.

25. The method of claim 1, further comprising at least one of the following:
establishing a subscription associated with said person, wherein said subscription entitles said person to receive said data;
receiving an indication of a subscription associated with said person, wherein said subscription entitles said person to receive said data.
establishing a subscription associated with said device, wherein said subscription entitles said person to receive information via a data perimeter.

26. The method of claim 1, further comprising at least one of the following:
receiving compensation as a result of said providing said data; and
determining a compensation due from said person.

27. A method for facilitating delivery of data, comprising:
determining a location associated with a person;
determining data associated with said person;
associating a data perimeter with said person based, at least in part, on said location, said perimeter including at least one transmitter capable of transmitting a wireless signal; and
providing said data to at least one of said at least one transmitter.

28. The method of claim 27, wherein said determining a location associated with a person includes at least one of the following:
detecting presence of said person at said location;
detecting presence of a device associated with said person at said location;
receiving a notification that said person is at said location;
receiving a notification that a device associated with said person is at said location;
receiving data indicative of said location;
receiving data from said person, said data being indicative of said location;
receiving data from a device associated with said person, said data being indicative of said location;
receiving a confirmation of said location from said person; and
requesting information regarding said location.

29. The method of claim 27, wherein said associating a data perimeter with said person based, at least in part, on said location, said perimeter including at least one transmitter capable of transmitting a wireless signal includes at least one of the following:
determining at least one transmitter within said location;
determining at least two transmitters that border said location;
determining at least one transmitter that can transmit said signal into a geographic area that includes said location;
determining at least three transmitters that from a boundary around said location;
selecting at least one transmitter based, at least in part, on a attribute of said person;
selecting at least one transmitter based, at least in part, on a attribute of said location;
selecting at least one transmitter based, at least in part, on a attribute of said at least one transmitter;
selecting at least one transmitter based, at least in part, on a attribute of said data;
selecting at least one transmitter based, at least in part, on a attribute of a device associated with said person;
receiving a signal that a device associated with said person is within range of said at least one transmitter;
determining at least one of a plurality of transmitters based, at least in part, on accessibility of said at least one of said plurality of transmitters;
determining at least one of a plurality of transmitters based, at least in part, on data transfer rate of said at least one of said plurality of transmitters;
determining at least one of a plurality of transmitters based, at least in part, on availability of said at least one of said plurality of transmitters; and
determining at least one of a plurality of transmitters based, at least in part, on bandwidth of a communication channel to said at least one of said plurality of transmitters.

30. The method of claim 27, wherein said providing said data to said at least one transmitter includes at least one of the following:
determining a communication channel to a device associated with said person;
providing said data to a transmitter nearest said location;
providing said data to at least one transmitter that can transmit said signal into a geographic area that includes said location;
providing said data to a transmitter capable of transmitting said data to a device associated with said person; and
providing an electronic communication that includes said data to at least one of a plurality of transmitters.

31. A method for facilitating delivery of data, comprising:
determining a data perimeter associated with a person, wherein said data perimeter includes at least one transmitter capable of sending a wireless signal;
determining data to be provided to said person; and
providing said data to said data perimeter.

32. The method of claim 31, wherein said determining a data perimeter associated with a person, wherein said data perimeter includes at least one transmitter capable of sending a wireless signal includes at least one of the following:
receiving an indication of said data perimeter;
determining at least one transmitter within a location associated with said person;
determining at least two transmitters that border a location associated with said person;
determining at least three transmitters that from a boundary around a location associated with said person;
determining at least one transmitter that can transmit said signal into a geographic area that includes said location;
selecting at least one transmitter based, at least in part, on a attribute of said person;
selecting at least one transmitter based, at least in part, on a attribute of said location;
selecting at least one transmitter based, at least in part, on a attribute of said at least one transmitter;
selecting at least one transmitter based, at least in part, on a attribute of data associated with said person;
selecting at least one transmitter based, at least in part, on a attribute of a device associated with said person;
receiving a signal that a device associated with said person is within range of said at least one of said plurality of transmitters;
determining at least one transmitter based, at least in part, on accessibility of said at least one transmitter;
determining at least one transmitter based, at least in part, on data transfer rate of said at least one transmitter;
determining at least one transmitter based, at least in part, on availability of said at least one transmitter; and
determining at least one transmitter based, at least in part, on bandwidth of a communication channel to said at least one transmitter.

33. The method of claim 31, wherein said providing said data to said data perimeter includes at least one of the following:
providing said data to a transmitter nearest a location of said person;
providing said data to a transmitter nearest a location of a device associated with said person;
providing said data to at least one transmitter that can transmit said signal into a geographic area that includes a location of said person;
providing said data to at least one transmitter that can transmit said signal into a geographic area that includes a location of a device associated with said person;
providing an electronic communication that includes the data to at least one transmitter in the data perimeter;
providing said data to a transmitter capable of transmitting said data to a device associated with said person; and
providing an electronic communication that includes said data to said data perimeter.

34. The method of claim 31, wherein said data perimeter includes a plurality of transmitters.

35. A method for facilitating delivery of data, comprising:
determining data to be provided at a location;
determining a data perimeter associated with said location, wherein said data perimeter includes at least one transmitter capable of sending a wireless signal; and
providing said data to said data perimeter.

36. The method of claim 35, wherein said determining data to be provided to a location includes at least one of the following:
determining data to be displayed to a person at said location;
determining data associated with a person at said location;
determining data associated with a device at said location;
receiving a request to provide said data to a person at said location;
receiving an instruction to provide said data to a person at said location;
receiving a request to provide said data at said location; and
receiving an instruction to provide said data at said location.

37. The method of claim 35, wherein said determining a data perimeter associated with said location includes at least one of the following:
receiving an indication of said data perimeter;
determining at least one transmitter within said location;
determining at least two transmitters that border said location;
determining at least three transmitters that from a boundary around said location;
determining at least one transmitter that can transmit said signal into a geographic area that includes said location;
selecting at least one transmitter based, at least in part, on an attribute of a person at said location;
selecting at least one transmitter based, at least in part, on a attribute of said location;
selecting at least one transmitter based, at least in part, on a attribute of said at least one transmitter;
selecting at least one transmitter based, at least in part, on a attribute of said data;
selecting at least one transmitter based, at least in part, on a attribute of a device at said location;
receiving a signal that a device associated with a person who within range of said at least one of said plurality of transmitters;
determining at least one of a plurality of transmitters based, at least in part, on accessibility of said at least one of a plurality of transmitters;
determining at least one of a plurality of transmitters based, at least in part, on data transfer rate of said at least one of said plurality of transmitters;
determining at least one of a plurality of transmitters based, at least in part, on availability of said at least one of said plurality of transmitters; and
determining at least one of a plurality of transmitters based, at least in part, on bandwidth of a communication channel to said at least one of said plurality of transmitters.

38. A method for facilitating delivery of data, comprising:
determining a device associated with a person;
determining data associated with a data perimeter, wherein said data is to be provided to said device; and
providing said data to said device.

39. The method of claim 38, further comprising:
determining a location of said device.

40. The method of claim 38, further comprising:
determining a location of said person.

41. The method of claim 38, further comprising:
determining said data perimeter.

42. The method of claim 38, wherein said data associated with a data perimeter includes at least one of the following:
information regarding an attribute of said data perimeter;
information regarding an attribute of a transmitter that is included in said data perimeter;
information regarding a geographic area covered by said data perimeter;
information regarding an object within a geographic area covered by said data perimeter;
information regarding an individual within a geographic area covered by said data perimeter;
information regarding a building within a geographic area covered by said data perimeter; and
information regarding an vehicle within a geographic area covered by said data perimeter.

43. The method of claim 38, wherein said device can display at least a portion of said data associated with said data perimeter when said person is in a location covered by said data perimeter.

44. The method of claim 38, wherein said determining data associated with a data perimeter, wherein said data is to be provided to said device includes at least one of the following:
determining a data perimeter that covers said location;
determining data associated with said person regarding a data perimeter that covers said location;
determining data to be provided to said device via said data perimeter when said device is in said location; and
determining data to be provided to said person via said data perimeter when said device is in said location.

45. The method of claim 38, wherein said determining data associated with a data perimeter, wherein said data is to be provided to said device includes at least one of the following:
determining information regarding a location of said data perimeter;
determining information regarding a transmitter that is included in said data perimeter;
determining information regarding a geographic area covered by said data perimeter;
determining information regarding an object within a geographic area covered by said data perimeter;
determining information regarding an individual within a geographic area covered by said data perimeter;
determining information regarding a building within a geographic area covered by said data perimeter; and
determining information regarding an vehicle within a geographic area covered by said data perimeter.

46. A system for providing data, comprising:
a memory;
a communication port; and
a processor connected to said memory and said communication port, said processor being operative to:
determine a data perimeter associated with a person;
determine data to be provided to said person; and
provide said data to said data perimeter.

47. A computer program product in a computer readable medium for providing data, comprising:
first instructions for identifying a data perimeter associated with a person;
second instructions for identifying data to be provided to said person; and
third instructions for sending said data to said data perimeter.

48. A system for providing data, comprising:
a memory;
a communication port; and
a processor connected to said memory and said communication port, said processor being operative to:
determine data to be provided at a location;
determine a data perimeter associated with said location; and
provide said data to said data perimeter.

49. A computer program product in a computer readable medium for providing data, comprising:
first instructions for identifying data to be provided at a location;
second instructions for identifying a data perimeter associated with said location; and
third instructions for sending said data to said data perimeter.
